(19) United States
(12) Patent Application Publication
(10) Pub. No.: US 2025/0083309 A1
(43) Pub. Date: Mar. 13, 2025

(54) GEOMETRIC POLICY FABRICS FOR ACCELERATED LEARNING IN ROBOTICS SYSTEMS, PLATFORMS, AND APPLICATIONS

(71) Applicant: NVIDIA Corporation, Santa Clara, CA (US)

(72) Inventors: Nathan Donald RATLIFF, Seattle, WA (US); Karl VAN WYK, Issaquah, WA (US); Ankur HANDA, Seattle, WA (US); Viktor MAKOVIICHUK, Santa Clara, CA (US); Yijie GUO, Seattle, WA (US); Jie XU, Bellevue, WA (US); Tyler LUM, Seattle, WA (US); Balakumar SUNDARALINGAM, San Jose, CA (US); Jingzhou LIU, Oakville (CA)

(73) Assignee: NVIDIA Corporation, Santa Clara, CA (US)

(21) Appl. No.: 18/646,312

(22) Filed: Apr. 25, 2024

Related U.S. Application Data
(60) Provisional application No. 63/537,452, filed on Sep. 8, 2023.

(51) Int. Cl. B25J 9/16

(52) U.S. Cl. CPC B25J 9/163; B25J 9/161; B25J 9/1664

(57) ABSTRACT

In various examples, systems and methods are disclosed relating to geometric fabrics for accelerated policy learning and sim-to-real transfer in robotics systems, platforms, and/or applications. For example, a system can provide an input indicative of a goal pose for a robot to a model to cause the model to generate an output, the output representing a plurality of points along a path for movement of the robot to the goal pose; and generate one or more control signals for operation of the robot based at least on the plurality of points along the path and a policy corresponding to one or more criteria for the operation of the robot. In examples, the system can provide the one or more control signals to the robot to cause the robot to move toward the goal pose.

### CROSS-REFERENCE TO RELATED APPLICATIONS

This application claims the benefit of U.S. Provisional Application No. 63/537,452, filed on Sep. 8, 2023, the contents of which are hereby incorporated by reference in their entirety.

### BACKGROUND

While early robotic systems were limited mechanically in the number of linkages and joints that could be implemented, recent improvements in robot design have enabled the use of smaller and more capable actuators at the joints of a robot. As the capabilities of these systems improve, so too does the desire to configure these systems to perform increasingly complex movements. But repeated actuation and braking at the joints needed to effect this motion can quickly wear down the mechanical actuators at the joints. Additionally, conventional path planning techniques that are involved in determining motion of components of robotic systems require increasing computing resources, since the number of joints increases the kinematic complexity of the robotic system's motion, making some mechanically possible maneuvers computationally infeasible.

### SUMMARY

Embodiments of the present disclosure relate to geometric fabrics for accelerated policy learning and sim-to-real transfer in robotics systems, platforms, and applications. In contrast to conventional systems, such as those described above, systems and methods developed in accordance with the present disclosure enable the implementation of models and policies that support performance of increasingly complex maneuvers by highly actuated robots.

At least one aspect relates to one or more processors. The one or more processors can include one or more circuits to provide an input (e.g., indicative of a goal or target pose for a robot) to a model to cause the model to generate an output. The output can represent a plurality of points along a path for movement of the robot to the goal pose. The one or more circuits can generate one or more control signals for operation of the robot based at least on the plurality of points along the path and a policy. The policy can correspond to one or more criteria for the operation of the robot. The one or more circuits can provide the one or more control signals to the robot, to cause the robot to move toward the goal pose.

In some implementations, the model is a reinforcement learning-based model. The reinforcement learning-based model can be trained and/or updated to generate the output based at least on the policy. When providing the input indicative of the goal pose for the robot to the model, the one or more circuits can provide an initial pose of the robot relative to an environment, the goal pose for the robot relative to the environment, and a pose of one or more objects relative to the environment in which the robot is operating to the model. Providing the input can cause the model to generate the output.

In some implementations, when generating the one or more control signals for operation of the robot, the one or more circuits can determine a set of control signals to move the robot between a first pose and at least one intermediate pose along the path based at least on the output of the model. The one or more circuits can provide the set of control signals to cause a second output to be generated. The second output can include an updated set of control signals representing an updated path that is compliant with a geometric fabric. At least one (e.g., each) control signal of the set of control signals can be configured to cause at least one actuator associated with a corresponding joint of the robot to move at least a portion of the robot from the first pose to a second pose of the at least one intermediate pose.

In some implementations, the one or more circuits can determine a type of maneuver associated with the input to the model. When providing the input to the model, the one or more circuits can: provide the input to the model based at least on the type of maneuver associated with the path. When providing the input to the model, the one or more circuits can determine the model from among a plurality of models, the model associated with the robot, and can provide the input to the model based at least on determining the model. In some implementations, the one or more criteria represented by the policy include at least one criteria based at least on a second-order differential equation.

In some implementations, the one or more circuits can simulate operation of the robot in a simulated environment. The one or more circuits that provide the one or more control signals to the robot to cause the robot to move toward the goal pose can provide the one or more control signals to the robot while operating in the simulated environment to cause the robot to move in the simulated environment.

In some implementations, the processor is included in at least one of a system implemented using a robot; a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing generative AI operations; a system for generating or presenting at least one of augmented reality content, virtual reality content, or mixed reality content; a system for hosting one or more real-time streaming applications; a system for implementing large language models (LLMs); a system for implementing vision language models (VLMs); a system implemented using an edge device; a system for performing conversational AI operations; a system for generating synthetic data; a system incorporating one or more virtual machines (VMs); a system implemented at least partially in a data center; or a system implemented at least partially using cloud computing resources.

At least one aspect relates to a system. The system can include one or more processors to perform operations comprising: providing an input indicative of a goal pose for a robot to a model to cause the model to generate an output, the output representing a plurality of points along a path for movement of the robot to the goal pose; generating one or more control signals for operation of the robot based at least on the plurality of points along the path and a policy corresponding to one or more criteria for the operation of the robot; and/or providing the one or more control signals to the robot to cause the robot to move toward the goal pose.

At least one aspect relates to a method. The method can include providing an input indicative of a goal pose for a robot to a model to cause the model to generate an output, the output representing a plurality of points along a path for movement of the robot to the goal pose; generating one or more control signals for operation of the robot using the plurality of points along the path and based at least on a policy corresponding to one or more criteria for the operation of the robot; and providing the one or more control signals to the robot to cause the robot to move toward the goal pose.

The processors, systems, and/or methods described herein can be implemented by or included in at least one of a system implemented using a robot; a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for generating or presenting at least one of augmented reality content, virtual reality content, or mixed reality content; a system for hosting one or more real-time streaming applications; a system for performing generative AI operations; a system for implementing large language models (LLMs); a system for implementing vision language models (VLMs); a system implemented using an edge device; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for implementing geometric fabrics for accelerated policy learning and sim-to-real transfer in robotics systems, platforms, and applications are described in detail below with reference to the attached drawing figures, wherein:

FIG. 1A is a block diagram illustrating an example system enabling geometric fabrics for accelerated policy learning and/or sim-to-real transfer in robotics systems, platforms, and/or applications, in accordance with some embodiments of the present disclosure;

FIG. 1B is a block diagram representing a data flow (e.g., associated with the robotic system of FIG. 1A);

FIG. 2 is a flow diagram of an example method involving the implementation of geometric fabrics for accelerated policy learning and/or sim-to-real transfer in robotics systems, platforms, and/or applications, in accordance with some embodiments of the present disclosure;

FIG. 3 is an example set of motions performed by a robotic system, in accordance with some embodiments of the present disclosure;

FIG. 4A is an illustration of an example autonomous vehicle, in accordance with some embodiments of the present disclosure;

FIG. 4B is an example of camera locations and fields of view for the example autonomous vehicle of FIG. 4A, in accordance with some embodiments of the present disclosure;

FIG. 4C is a block diagram of an example system architecture for the example autonomous vehicle of FIG. 4A, in accordance with some embodiments of the present disclosure;

FIG. 4D is a system diagram for communication between cloud-based server(s) and the example autonomous vehicle of FIG. 4A, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to geometric fabrics for accelerated policy learning and sim-to-real transfer in robotics systems, platforms, and/or applications, such as for the control of robotic systems during operation of an autonomous robotic machine, or an autonomous moving robot. The systems described herein can include, for example and without limitation, industrial robots (e.g., robots operating in environments with at least some barriers relative to locations of people or various objects), collaborative robots (e.g., robots that may be operated in environments that do not have such barriers), autonomous robots, robotic arms and/or end effectors, surgical robots, and autonomous vehicles. In various such implementations, robotic systems may be expected to be capable of reacting to (e.g., modifying behavior responsive to) changes in the environment and states of objects or other entities in or associated with the environment.

In various embodiments, the systems and methods described herein may be used by, without limitation, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, non-autonomous vehicles or machines, semi-autonomous vehicles or machines (e.g., in one or more adaptive driver assistance systems (ADAS)), autonomous vehicles or machines, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems for performing generative AI operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

In an example, systems described herein can provide an input indicative of a goal pose for a robot to a model to cause the model (e.g., a reinforcement learning-based model trained and/or updated in accordance with a geometric fabric as described herein) to generate an output, the output representing a plurality of points along a path for movement of the robot to the goal pose. The systems can then generate one or more control signals for operation of the robot based at least on the plurality of points along the path and a policy corresponding to one or more criteria for the operation of the robot. The policy can represent the geometric fabric that was used to train and/or update the model. The systems can then provide the one or more control signals to the robot to cause the robot to move toward the goal pose.

In some implementations, various types of maneuvers can be generated and associated with motion of a robot along a given path. For example, maneuvers such as grasping maneuvers, path planning maneuvers, and/or the like are described, each involving different goals for the robotic system (e.g., contacting/grasping an object vs. navigating toward, away from, and/or around the object). In some implementations, these maneuvers can be determined and used to generate the control signals. The criteria underlying the geometric fabric can be based at least on (e.g., can represent) a second-order differential equation, such as a function that includes term(s) such as (i) mass and motion of the robotic system; (ii) force(s) on the robotic system; and/or (iii) a policy-based action for the robotic system.

By implementing the techniques described herein, robotic systems controlling the movement of a robot across one or more poses toward a goal pose within an environment can translate the path(s) along which the robot moves into corresponding control signals that closely align with the path(s) while remaining compliant with the operational capabilities of the robot. This results in an increased probability that the control signals ultimately used to effect movement of the robot result in operation of the robot within the operational limits of the components of the robot, thereby reducing or eliminating the probability of inadvertent stress on the robot that go beyond normal wear and tear. Further, the ability of robotic systems to scale (e.g., increase the number of actuators that can be controlled in coordination by the robotic system when operating a robot) can be improved while reducing the corresponding need for increasing computational resources. As a result, unlike conventional techniques that can reasonably ensure safe control of robots having between 1-3 actuators, the presently disclosed techniques allow for the safe and coordinated control of robots having up to 15-20 or more actuators.

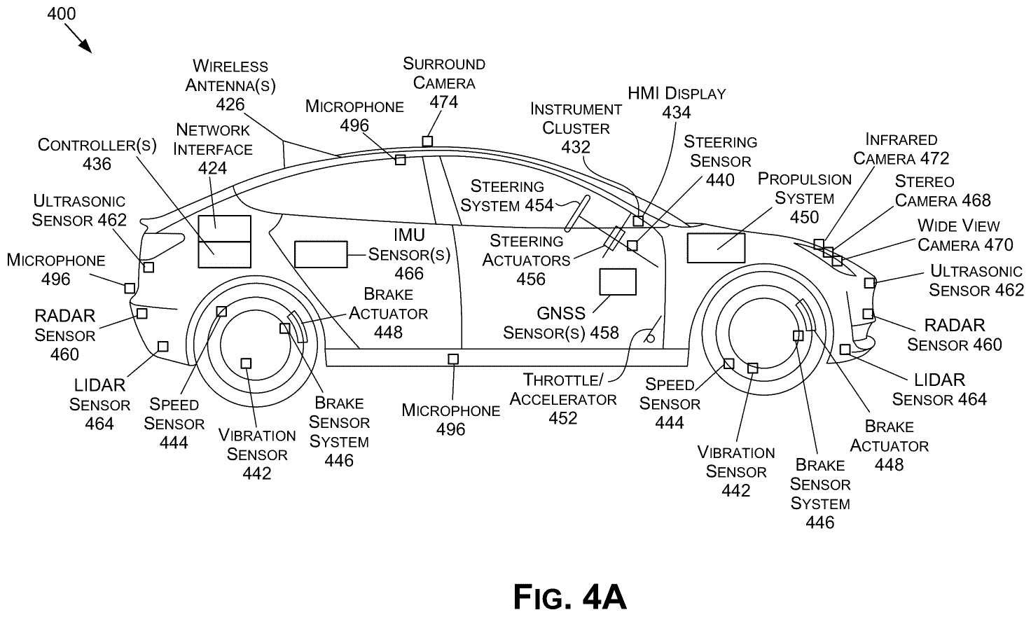

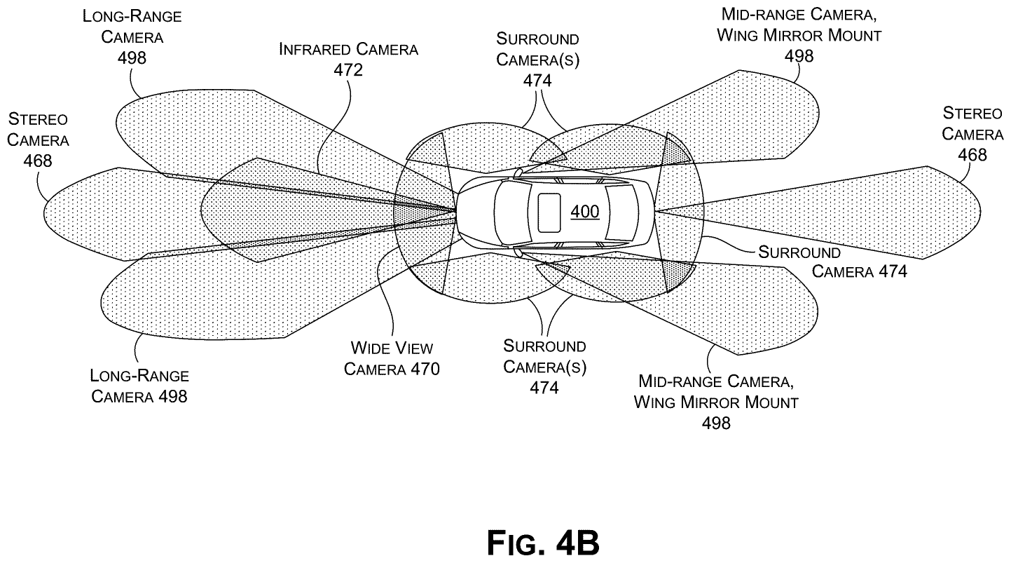

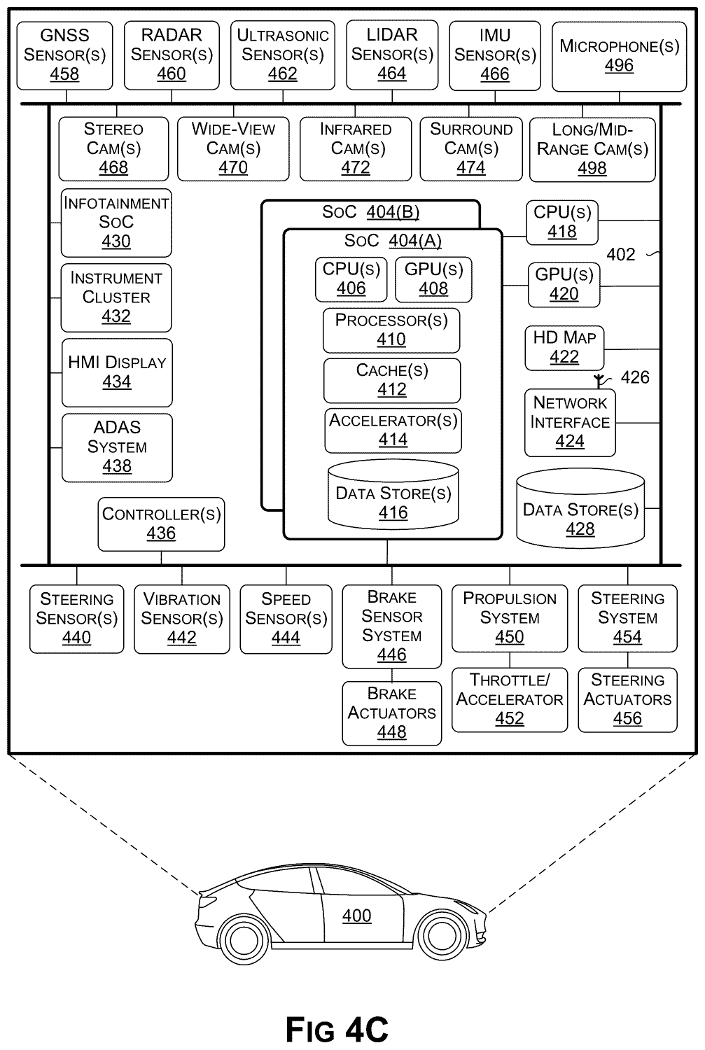

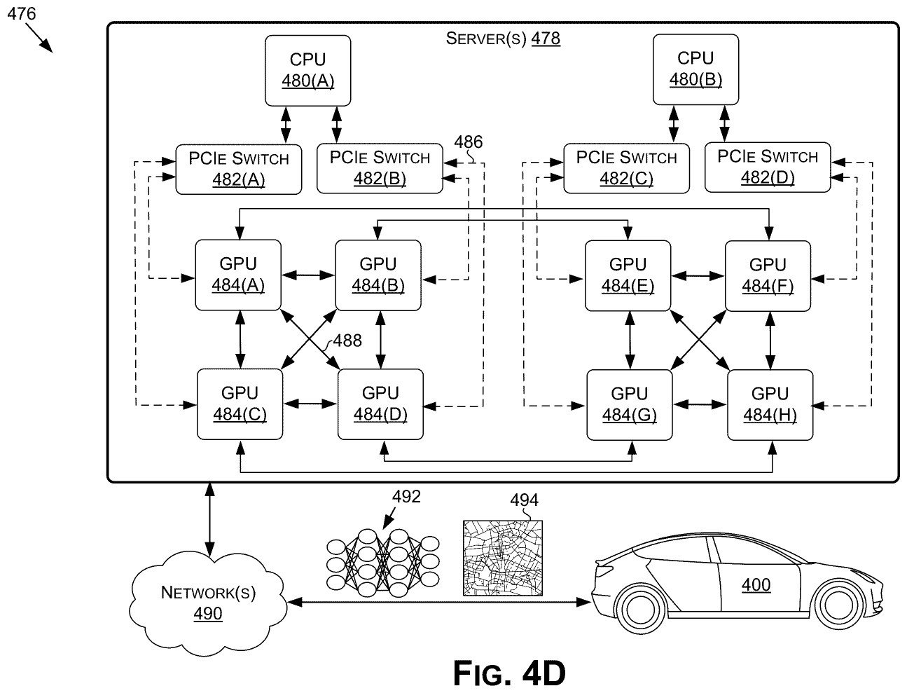

Although the present disclosure may be described with respect to an example robot 110 or an example autonomous vehicle 400 (alternatively referred to herein as “vehicle 400”, “ego-vehicle 400,” and/or “machine 400”) an example of which is described with respect to FIGS. 4A-4D), this is not intended to be limiting. For example, the systems and methods described herein may be used by, without limitation, any highly-actuated robotic system where multiple actuators work in coordination to control motion of a robot as the robot moves through an environment and interacts with objects in that environment. In addition, although the present disclosure may be described with respect to the control of robots operating in a real-world or simulated environment, this is not intended to be limiting, and the systems and methods described herein may be used in augmented reality, virtual reality, mixed reality, robotics, security and surveillance, autonomous or semi-autonomous machine applications, and/or any other technology spaces where the implementation of models and policies as described herein can improve the operation of highly actuated robots.

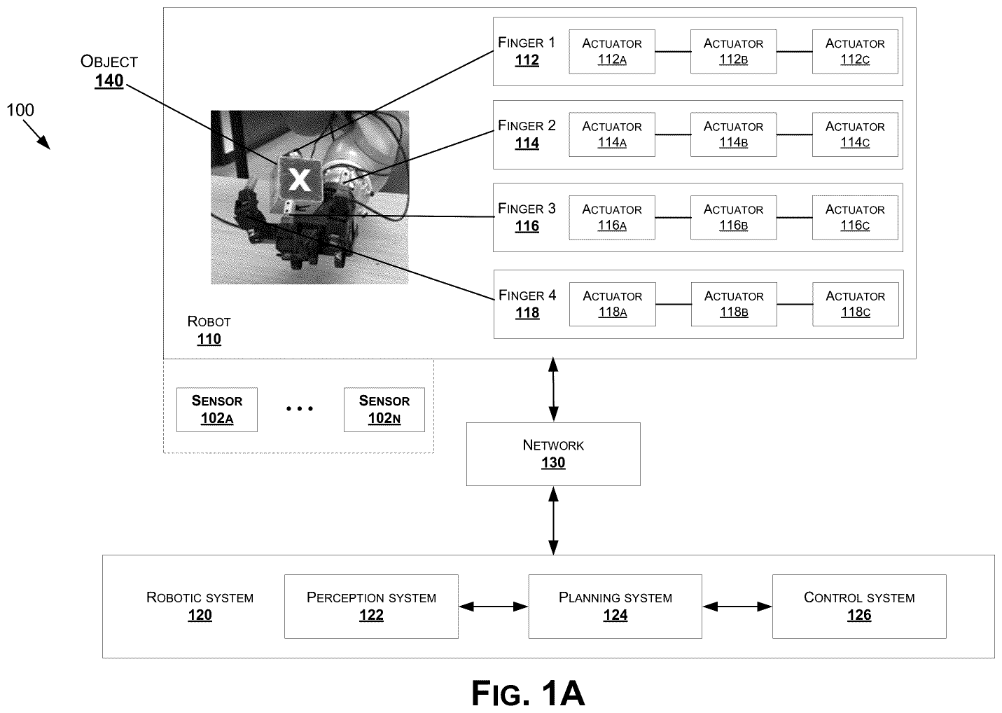

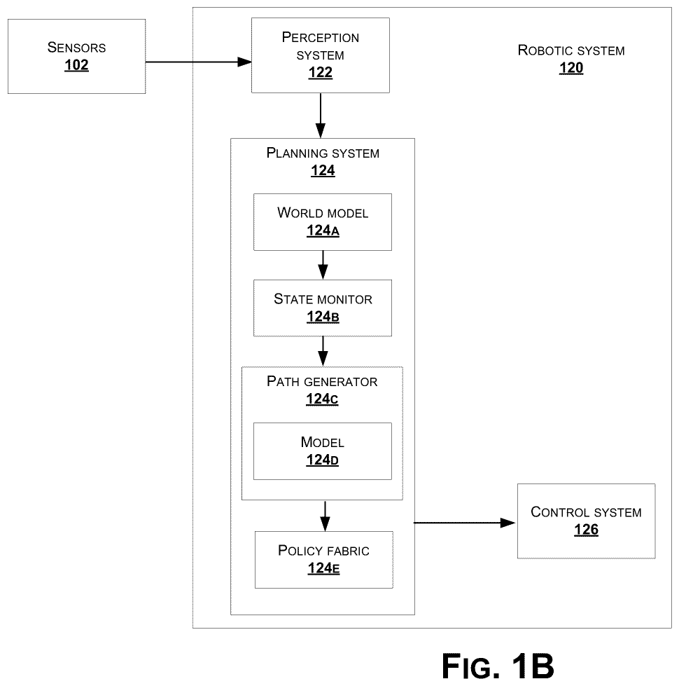

With reference to FIG. 1A, FIG. 1A is an example environment 100, in accordance with some embodiments of the present disclosure. As depicted in FIG. 1A, the environment 100 includes a robot 110, a robotic system 120, and a network 130. The robot 110 can be in communication with the robotic system 120 via the network 130. For example, the robot 110 can be in communication with the robotic system 120 to enable the robotic system 120 to receive data generated in association with operation of the robot 110 (e.g., sensor data generated by the sensors 102, kinematic data generated by one or more components of the robot 110, and/or the like) and provide (e.g., transmit, make available for download, and/or the like) control signals to control operation of the robot 110. In examples, operation of the robot can include causing components of the robot 110 to move such that the robot 110 transitions from a first pose (e.g., an initial pose or intermediate pose(s)) to a second pose (e.g., intermediate pose(s) or a goal pose). It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The environment 100 or components thereof can implement any function, model (e.g., machine learning model, neural network, data representation of an environment or object or agent in the environment, and/or the like), operation, rules, heuristics, algorithms, routine, logic, or instructions to perform functions such as operating a computing device to reactively control components of a robot or similar devices responsive to sensor inputs, such as real-world or synthetic (e.g., virtual) sensor data indicative of an environment and objects in the environment.

In some embodiments, the robot 110 can be operated and/or trained or updated in real-world (e.g., physical) environments, in virtual (e.g., simulated) environments, or in a mix of both real-world and virtual environments. For example, the robot 110 can include sensors 102 that generate sensor data representing aspects of a real-world environment or virtual environment, respectively. The robot 110 can transmit the sensor data to the robotic system 120 to enable to robotic system 120 to generate control signals based at least on the sensor data. The robotic system 120 can then transmit the control signals to the robot 110 to cause the robot to operate (e.g., move within the environment, interact with objects in the environment, and/or the like) based at least on the control signals. In embodiments, the robot 110 is operated by the robotic system 120 in a virtual environment during training and/or updating of one or more components of the robotic system 120. Such operation can be associated with interactions between the robot 110 and the environment 100 that are simulated to enable training and/or updating of one or more reinforcement learning-based models implemented by the robotic system 120, as described herein.

In some embodiments, the robot 110 includes one or more sensors 102a-102n (referred to individually as sensor 102 and collectively as sensors 102). For example, the sensors 102 can include any variety of sensors such as stereo cameras, wide-view cameras, infrared camera, surround cameras, long-range and/or mid-range cameras, radio detection and ranging (RADAR) sensors, light detection and ranging (LiDAR) sensors, ultrasonic sensor, inertial measurement unit sensors, speed sensors, encoders, and/or the like. In some examples, the sensors 102 can be included in (e.g., supported by, coupled to, and/or the like) one or more components of the robot 110. In examples, the sensors 102 can be included in the environment 100 apart from the robot 110 and in communication with the robot 110 and/or the robotic system 120 via directed (e.g., wired or wireless) connections or indirect connections (e.g., via the network 130). In some embodiments, the sensors 102 output sensor data periodically or in response to requests for the sensor data from the robotic system 120. In some embodiments, the sensors 102 generate sensor data and transmit the sensor data to the robot 110 and/or the robotic system 120. For example, the sensors 102 can generate sensor data during operation of the robot 110 and transmit the sensor data to the robot 110 and/or the robotic system 120 to enable the robot 110 and/or the robotic system 120 to perform one or more of the functions described herein based at least on the sensor data.

In some embodiments, the robot 110 includes a highly-actuated robot. For example, the robot 110 can include one or more manipulators, e.g., one or more fingers 112, 114, 116, 118. Each finger 112, 114, 116, 118 can include one or more actuators, respectively. For example, a first finger (“finger 1”) 112 can include a first actuator 112a, a second actuator 112b, and a third actuator 112c; a second finger (“finger 2”) 114 can include a first actuator 114a, a second actuator 114b, and a third actuator 114c, a third finger (“finger 3”) 116 can include a first actuator 116a, a second actuator 116b, and a third actuator 116c, and a fourth finger (“finger 4”) 118 can include a first actuator 118a, a second actuator 118b, and a third actuator 118c. With respect to each finger 112, 114, 116, 118, the actuators can be coupled to respective linkages of the fingers 112, 114, 116, 118 such that the linkages can be moved relative to one another and/or relative to objects 140 within the environment 100 based at least on selective activation and inactivation of respective actuators. In some embodiments, the actuators of each finger 112, 114, 116, 118 can be configured to receive control signals (e.g., control signals generated by the robotic system 120) and be activated or inactivated based at least on the control signals. In this way, the robot 110 can be operated such that the fingers 112, 114, 116, 118 can work in coordination to effect independent movement of the fingers 112, 114, 116, 118 when cooperatively engaging with an object 140 in the environment 100. While the robot 110 is described herein as a highly-actuated robot including fingers 112, 114, 116, 118, such description is for illustrative purposes. It will be understood that the robot 110 can include one or more arms (e.g., arms including multiple linkages coupled with respective actuators), legs (e.g., legs including multiple linkages coupled with respective actuators), and/or the like.

Referring now to FIGS. 1A and 1B, the robotic system 120 includes a perception system 122. In some embodiments, the perception system 122 can receive the sensor data generated by the sensors 102 during operation of the robot 110. For example, the perception system 122 can receive the sensor data generated by the sensors 102 during operation of the robot 110, where the sensor data is associated with (e.g., represents) one or more characteristics of one or more objects in the environment 100. In an example, the perception system 122 can determine, based at least on the received sensor data, one or more poses of one or more objects in the environment 100. In this example, the perception system 122 can determine the one or more poses relative to a pose of the robot 110 that is located in the environment 100. In examples, the perception system 122 can perform, based at least on the received sensor data, one or more object detection processes (e.g., involving computer vision-based techniques, neural networks-based techniques, template matching-based techniques, and/or the like). In this example, the perception system 122 can determine the one or more characteristics of the one or more objects in the environment based at least on the perception system 122 performing the one or more object detection processes. In some embodiments, the perception system 122 can determine one or more characteristics of the one or more objects in addition to, or alternative to, the poses of the one or more objects in the environment 100. For example, the perception system 122 can determine characteristics including positions (e.g., in a local frame of reference of the respective sensors 102, a global frame of reference established based at least on the position of the sensors 102, and/or the like), orientations, sizes, colors, motion (e.g., velocity, acceleration, rotation), and/or the like of objects that are in the environment 100. In some embodiments, the perception system 122 can provide data associated with the characteristics of the one or more objects in the environment 100 to planning system 124 to enable the planning system 124 to implement one or more functions as described herein.

The robotic system 120 can include a planning system 124. The planning system 124 can receive the data associated with the characteristics of the one or more objects generated by the perception system 122. For example, the planning system 124 can receive the data associated with the characteristics of the one or more objects generated by the perception system 122 during operation of the robot 110. In some embodiments, the planning system 124 can plan motion of the robot 110 based at least on the data associated with the characteristics of the one or more objects in the environment 100. In some embodiments, the planning system 124 can plan motion of the robot 110 based at least on the planning system receiving kinematic data generated by one or more components of the robot 110. In some embodiments, the planning system 124 can plan the motion of the robot 110 based at least on the planning system 124 implementing one or more of a world model 124a, a state monitor 124b, a path generator 124c, or a policy fabric 124e, as described herein. As will be described later, the planning system 124 may be implemented in environment 100, where the environment 100 is a virtual environment and the robotic system 120 is being trained and/or updated in accordance with one or more machine learning-based techniques (e.g., reinforcement learning-based techniques and/or the like) to operate the robot 110 in the environment 100.

In some embodiments, the planning system 124 can determine a world model 124a, where the world model 124a includes a representation of the environment 100. For example, the planning system 124 can determine a world model 124a that includes a representation of the environment 100, where the representation includes positions and/or poses of the robot 110 and one or more objects 140 located in the environment 100. The world model 124a can be associated with a frame of reference that can be (without limitation) the same as, similar to, or modified/augmented versions of frames of reference associated with the sensors 102. The world model 124a can include a two-dimensional (2D) or three dimensional (3D) representation of the environment 100, the 2D or 3D representation being associated with a coordinate system (e.g., an X-Y-Z coordinate system). The planning system 124 can maintain the world model 124a in various manners, such as by using a universal scene description (USD) representation.

In some embodiments, the planning system 124 implements a state monitor 124b. For example, the planning system 124 can implement a state monitor 124b based at least on the planning system 124 evaluating the world model 124a. In examples, a state determined by the state monitor 124b can represent a logical state (e.g., true/false, categorical state, and/or the like) of the environment 100, the robot 110, one or more objects 140, and/or the like. In some embodiments, the planning system 124 can implement the state monitor 124b based at least on the planning system 124 evaluating the world model 124a in accordance with one or more rules, threshold, conditions, functions, algorithms, and/or the like, when determining states of the environment 100. For example, the planning system 124 can evaluate the world model 124a and the planning system 124 can determine one or more states associated with the environment 100 based at least on the state of the world model 124a. The states can represent, for example, positions of the robot 110 and/or objects 140 relative to the environment 100, distances (e.g., distances between the robot 110 and objects 140), whether objects are supported (e.g., held, grasped, and/or the like) or not supported by the robot 110 (e.g., by one or more fingers 112, 114, 116, 118 of the robot 110), whether the robot 110 or one or more objects 140 are associated with positions, orientations, temperatures, pressures, colors, or other parameters that satisfy respective conditions, and/or the like. In some embodiments, the state monitor 124b can be implemented such that the state monitor 124b determines, according to an orientation and/or a pose of an object 140, whether the object 140 is in one or more predetermined orientations and/or poses. In some embodiments, the state monitor 124b can be implemented such that the state monitor 124b determines one or more relations between the robot 110 and the object 140, including, for example and without limitation, whether the object 140 is being supported or not supported by the robot 110, whether the robot 110 is within a threshold distance of the object 140, whether the robot 110 is moving (e.g., across multiple time steps) toward or not toward the object 140, and/or the like. In some embodiments, the planning system 124 implements the state monitor 124b such that the state monitor 124b maintains (e.g., in memory) a current state and/or one or more previous states of the environment 100. In some embodiments, the state monitor 124b makes one or more of the determinations described herein based at least on the one or more states maintained by the state monitor 124b. In some embodiments, the planning system 124 causes the state monitor 124b to transmit data associated with the state of the environment 100 (e.g., including states associated with the robot 110 and/or the object 140) to the path generator 124c.

In some embodiments, the planning system 124 implements a path generator 124c. For example, the planning system 124 can implement the path generator 124c based at least on the state of the environment 100. In some embodiments, the path generator 124c determines one or more control signals that can be transmitted to the robot 110 to cause the robot 110 to move toward a goal for the robot 110. In examples, the goal for the robot 110 can include a goal pose for the robot 110, a goal pose for one or more components (e.g., linkages, members, and/or the like) of the robot 110, a goal pose for one or more objects contacted by the robot 110, a goal state for the robot 110 representing a power level, temperature, initiation and/or performance of one or more operations, and/or the like. In examples, a goal pose may be a pose associated with movement of the robot 110 through the environment, engagement of the robot 110 with the object 140, non-engagement of the robot 110 with the object 140 (e.g., avoidance), and/or the like. In an illustrative example, engagement of the robot 110 with the object 140 can include movement of the robot 110 toward the object 140 and subsequent grasping of the object 140 by the robot 110. In this illustrative example, the engagement of the robot 110 with the object 140 can result in a change in the pose of the object 140 relative to the environment 100.

With continued reference to FIG. 1B, in some embodiments, the path generator 124c includes a model 124d. For example, the path generator 124c can include the model 124d that represents a policy, such as a policy that maps a state (e.g., a state of the environment 100 and/or one or more devices or objects in the environment 100) to one or more actions that can be performed by, for example, the robot 110. In this example, the model can include a reinforcement learning-based model that can include any one or more of a neural network, an artificial neural network, a deep neural network, a decision tree, a rule-based system, and/or the like that can correlate a state of the environment 100 (e.g., a state of the robot 110 as it operates within the environment) to one or more actions to be performed by the robot 110 based at least on the state of the environment 100. In some embodiments, the model 124d can be trained and/or updated based at least on the outputs of a policy fabric 124e as described herein.

In some embodiments, the model 124d receives as input a goal pose for the robot 110. In an example, the goal pose can represent a pose of the robot 110 in the environment 100 relative to an object 140. In examples, the model 124d receives the state of the environment 100 in addition to the goal pose of the robot 110. For example, the model 124d can receive the goal pose of the robot 110 and the state of the environment 100 that is determined by the state monitor 124b. In some embodiments, the model 124d generates an output. For example, the model 124d can generate the output based at least on the goal pose of the robot 110 and/or the state of the environment 100. In examples, the output of the model 124d can represent a plurality of points along a path for movement of the robot 110 toward the goal pose for the robot 110.

In some embodiments, the model 124d receives as input an initial pose of the robot 110 relative to the environment 100, a goal pose of the robot 110 relative to the environment 100, and a pose of the object 140 relative to the environment 100. For example, the model 124d can receive the goal pose of the robot 110 relative to the environment 100 and the state of the environment 100, where the state of the environment 100 represents the initial pose of the robot 110 relative to the environment and the pose of the object 140 relative to the environment 100. In some embodiments, the output of the model 124d represents a plurality of points along a path for movement of the robot 110 toward the goal pose for the robot 110. In embodiments, the output of the model 124d is associated with (e.g., includes) a set of control signals that are configured to cause the actuators of the fingers 112, 114, 116 to move toward poses associated with each point along the path (sometimes referred to as intermediate poses). In some embodiments, the planning system 124 provides the output of the model 124d to the policy fabric 124e.

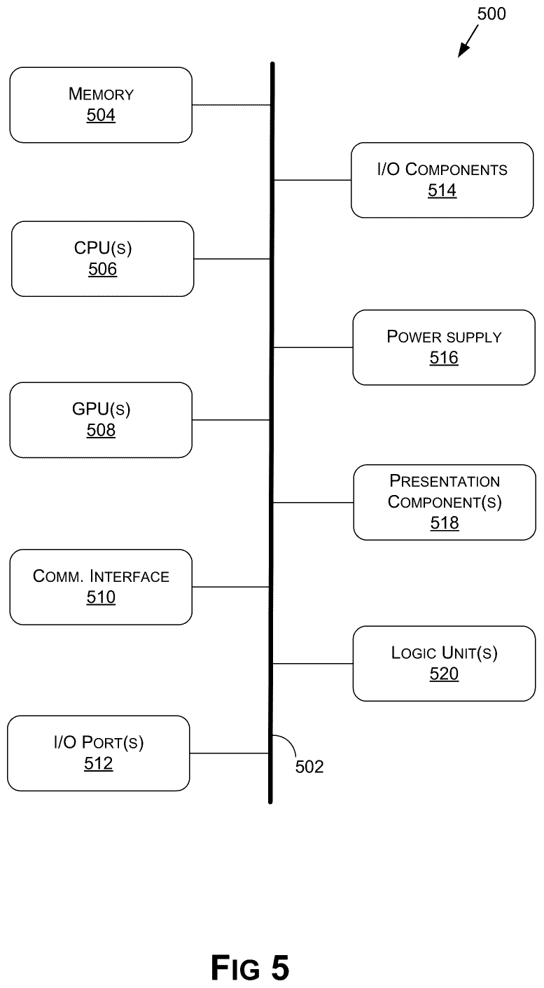

In some embodiments, the model 124d is trained and/or updated using reinforcement learning-based techniques. For example, using a simulator that is generating a simulated environment, the model 124d can be trained and/or updated based at least on operations performed by an agent moving within the simulated environment. In some embodiments, the simulator is implemented by a computing device that is the same as, or similar to, the computing device 500 of FIG. 5. In some embodiments, the simulated environment is a virtual environment that represents the environment 100. In some embodiments, the model 124d can be trained and/or updated in parallel based on operations performed at least partially simultaneously or concurrently by multiple agents—or instances of agents—moving within multiple instances of a simulated environment, or multiple instances of multiple simulated environments.

In some embodiments, during training and/or updating, the model 124d can be provided with an initial pose of the robot 110 relative to the simulated environment, a goal pose of the robot 110 relative to the simulated environment, and/or a pose of the object 140 relative to the simulated environment, and the model 124d can generate an output (e.g., representing a plurality of points along a path and/or a set of control signals). During simulation, the path generator 124c can provide the output to a policy fabric 124e. The policy fabric 124e can then be used (e.g., by the model 124d) to generate and provide a set of control signals based at least on the output of the path generator 124c to the simulator (e.g., via the control system 126) to cause the agent in the simulated environment to move from an initial pose to one or more intermediate poses while attempting to reach a goal pose.

During operation of the robot 110 in the simulated environment, a reward (e.g., reward score) can be assigned for successful movement of the robot 110 in the simulated environment toward the goal pose, and a penalty (e.g., penalty score) can be assigned for unsuccessful movement of the robot 110. In examples, successful movement of the robot 110 can include one or more of movement by the robot 110 where the movement results in the robot 110 advancing to the goal pose, the robot 110 not colliding with objects in the simulated environment (including objects other than the object 140 that the robot 110 is moving toward), and/or the like. In some examples, unsuccessful movement of the robot 110 can include movement by the robot 110 where the movement results in the robot 110 not advancing to the goal pose, the robot 110 colliding with objects in the simulated environment, and/or the like. In some embodiments, the model 124d can be trained and/or updated based at least on the rewards and the penalties assigned to the movements of the robot 110 within the simulated environment. Training and/or updating of the model 124d can continue until a number of rewards are obtained and a number of penalties are minimized (e.g., until the model 124d converges). In this way, the model 124d can be trained and/or updated based at least on rewards and penalties assigned to the movement of the robot 110 where the movement of the robot 110 is guaranteed to be in compliance with the geometric fabric implemented by the policy fabric 124e.

With continued reference to FIGS. 1A and 1B, in some embodiments, the planning system 124 includes and/or implements a policy fabric 124e. The policy fabric 124e can include one or more policies that represent second order differential equations, the policies configured to receive inputs as described herein and output control signals that can be used to operate the robot 110. For example, the planning system 124 can implement the policy fabric 124e based at least on the output of the path generator 124c. In examples, the planning system 124 can implement the policy fabric 124e based at least on the output of the path generator 124c, where the output represents the plurality of points along a path for movement of the robot 110 toward the goal pose for the robot 110. In some examples, the planning system 124 can implement the policy fabric 124e based at least on the output of the path generator 124c, where the output includes a set of control signals that are configured to cause the actuators of the fingers 112, 114, 116, 118 to move toward one or more intermediate poses as described above.

In embodiments where the policy fabric 124e receives the output of the model 124d, the output representing the plurality of points along the path for movement of the robot 110 toward the goal pose for the robot 110, the policy fabric 124e can generate one or more control signals. Additionally, or alternatively, where the policy fabric 124e receives the set of control signals that are configured to cause the actuators of the fingers 112, 114, 116, 118 to move the robot 110 toward one or more intermediate poses, the policy fabric 124e can generate one or more control signals (referred to in this context as updated control signals) based at least on the control signals generated by the path generator 124c. In each of these examples, the control signals that are output by the policy fabric 124e can satisfy one or more criteria for operation of the robot 110. For example, the policy fabric 124e can include one or more policies, each policy being associated with a second order differential equation as described herein that corresponds to one or more criteria for the operation of the robot 110. In one illustrative example, a policy of the policy fabric 124e can be associated with a rate of change of speed that is acceptable (e.g., within threshold tolerances) with respect to actuation of one or more of the actuators of the fingers 112, 114, 116, 118. In this example, when the policy fabric 124e receives an output from the model 124d representing the plurality of points along the path, the policy fabric 124e can generate control signals that cause the actuators of the fingers 112, 114, 116, 118 of the robot 110 to move to each point in accordance with rates of change of speed that are acceptable (e.g., that the actuators can tolerate/achieve/support with minimal wear and tear to the actuators). In examples, when the policy fabric 124e receives an output from the model 124d including control signals generated by the path generator 124c, the policy fabric 124e can generate updated control signals such that the updated control signals cause the actuators of the fingers 112, 114, 116 of the robot 110 to move to each point in accordance with rates of change of speed that are acceptable. In this way, the policy fabric 124e can provide either a path or a set of control signals representing the path to the policy fabric 124e to cause the policy fabric to generate control signals that enable movement of the robot 110 from pose to pose in compliance with the policy fabric 124e.

In some embodiments, the policy fabric 124e includes multiple polices that are stacked to represent a geometric fabric. For example, the policy fabric 124e can include multiple policies, each corresponding to criteria for operation of the robot 110. In some examples, the policies can be stacked (e.g., combined) so as to represent the geometric fabric, where the geometric fabric is associated with an action space (e.g., a range of control signals that the robot 110 can operate within while satisfying the criteria for operation of the robot 110). By training and/or updating the model 124d and processing the output of the path generator 124c based at least on the policy fabric 124e, the robotic system 120 can guarantee that the control signals generated to move the robot 110 between poses toward a goal pose satisfy the operational limits of the robot 110. In some embodiments, the policy fabric 124e transmits the one or more control signals to control system 126.

The robotic system 120 can include at least one control system 126. In some embodiments, the control system 126 receives the control signals from the planning system 124 and provides the control signals to respective components of the robot 110. For example, the control system 126 can receive the control signals and the control system 126 can provide the control signals to the actuators of the fingers 112, 114, 116 of the robot 110 to cause the robot 110 to move within the environment. In examples, the control system 126 can transmit the control signals as a set of control signals to the robot 110 to cause the actuators of the fingers 112, 114, 116 to move such that the robot 110 transitions from a current pose to an intermediate or goal pose.

### Formulating Geometric Fabrics

In some embodiments, the robotic system 120 reshapes the real second-order dynamics of the robot 110 via an artificial second-order dynamical system. These artificial second-order dynamical systems can be constructed based at least on families of geometric fabrics, described herein. In some embodiments, geometric fabrics implemented in accordance with the present disclosure can result in the generation of speed-invariant paths through an environment 100, automatically handle certain constraints (e.g., constraints associated with the criteria of the robot 110), capture useful, guiding tendencies, and expose an action space for operation of the robot 110 within the environment 100. Policies (e.g., policies associated with (e.g., used during the training of) the model 124d and/or the policy fabric 124e) can be used to issue actions in this space that are compliant with the geometric fabric, generating a combined behavior manifested by the robot 110. This mixing of artificial and real dynamics is sometimes referred to as behavioral dynamics.

In some embodiments, a geometric fabric can be represented as a stable second-order dynamical system. One example notation of a geometric fabric can include:

$$\begin{matrix}{\ddot{q}}_{f} = \tilde{h} ( {q}_{f} , {\dot{q}}_{f} ) + {α}_{ℒ} ( {q}_{f} , {\dot{q}}_{f} ) {\dot{q}}_{f} \\ - {M}_{f}^{- 1} ( {q}_{f} , {\dot{q}}_{f} ) ( {\partial }_{ψ} , {\dot{q}}_{f} ) + B \\ - β ( {q}_{f} , {\dot{q}}_{f} ) {\dot{q}}_{f} )\end{matrix} ( {q}_{f} , {\dot{q}}_{f} ) {\dot{q}}_{f} )$$

where M_{ƒ}∈ [symbol] ^{n×n} is the positive-definite system metric (mass), which captures system prioritization (dependencies dropped for brevity). \tilde{h}∈ [symbol] ⁿ is a geometric fabric which is homogeneous of degree two in velocity (HD2) to produce geometric paths through space (which can be interpreted as nominal system behavior). [symbol] ∈ [symbol] is an energization coefficient which ensures the fabric maintains a certain energy [symbol] ∂ψ∈ [symbol] ⁿ is the gradient of a potential function and B E [symbol] ^{n×n} a positive semi-definite damping matrix, both of which additionally perturb system acceleration from the nominal fabric. These can be used to impose constraints on the operation of the robot 110. Finally, β∈ [symbol] ⁺ is an additional damping scalar that can preserve the geometry of the geometric fabric and can serve to remove energy from the system, slowing the system down to ensure stability.

### Behavioral Dynamics

In some embodiments, the artificial dynamics associated with (e.g., governing) the above-represented geometric fabric can be compactly rewritten as:

$${M}_{f} ( {q}_{f} , {\dot{q}}_{f} ) {\ddot{q}}_{f} + {f}_{f} ( {q}_{f} , {\dot{q}}_{f} ) = 0$$

where q_{ƒ}, \dot{q}_{ƒ}, \ddot{q}_{ƒ}∈ [symbol] ⁿ are the position, velocity, and acceleration of the geometric fabric with n dimensions. Moreover, ƒ_{ƒ}∈ [symbol] ⁿ is the artificial force. These dynamics are connected to the real dynamics of the robot 110 as:

$$M ( q ) \ddot{q} + f ( q , \dot{q} ) = τ ( q , \dot{q} , {q}_{f} , {\dot{q}}_{f} , {\ddot{q}}_{f} )$$

where q_{ƒ}, \dot{q}_{ƒ}, \ddot{q}_{ƒ}∈ [symbol] ⁿ are the real position, velocity, and acceleration. M∈ [symbol] ^{n×n} and ƒ∈ [symbol] ⁿ are the real mass and force (including contact, Centripetal/Coriolis, friction, and gravity forces) of the robot 110. The torque control law, τ, connects the artificial and real dynamics together. A specific instantiation of this torque law is described below with respect to the control system 126.

With the behavioral dynamics above, a policy, π(·), (e.g., a model 124d and/or a policy fabric 124e) can produce a driving force on the geometric fabric by issuing actions (a, α˜π(·)), to a function ƒ_{π}(·), as

$${M}_{f} ( {q}_{f} , {\dot{q}}_{f} ) {\ddot{q}}_{f} + {f}_{f} ( {q}_{f} , {\dot{q}}_{f} ) + {f}_{π} ( a ) = 0 ,$$

where ƒ_{π}(a), is interpreted as a driving force on the geometric fabric. Consequently, the time evolution of the fabric state, (q_{ƒ}, \dot{q}_{ƒ}), is a function of the geometric fabric itself and the control forces produced by the policy. General control forces over second-order dynamical systems can include a control input that is applicable to many contexts including torque control laws for robots such as robot 110 and torque control inputs for trajectory optimization. In some embodiments, ƒ_{π}(α) can destabilize the artificial dynamics, but a sufficiently large B and β maintain system stability. Moreover, energy capping methods can guarantee stability even with a general driving force coming from ƒ_{π}(α).

### Torque Control

With continued reference to FIG. 1B, the control system 126 can include a joint-level proportional-derivative (PD) controller with inverse dynamics compensation. The control system 126 can facilitate tracking control which can mean that ∥q_{ƒ}−q∥≤ϵ₁∈ [symbol] ⁺ and ∥\dot{q}_{ƒ}−\dot{q}∥≤δ₂∈ [symbol] ⁺. Both ϵ₁, ϵ₂ can be driven to smaller values based at least on how much of the inverse dynamics are compensated and the magnitude of the PD gains. In embodiments involving a robot 110 moving in an environment 100, a geometric fabric can effectively replace the real dynamics since q≈q_{ƒ} and \dot{q}≈\dot{q}_{ƒ}. More generally, the controllable robot states and the associated geometric fabric state can closely match in free-space and separate during contact. This separation induces contact forces, which can be leveraged to perform mechanical work, e.g., object manipulation.

Various aspects of the systems associated with environment 100 can be implemented by one or more devices or systems that can be communicatively coupled with one another. For example, the robotic system 120 can be implemented by a controller or operating system of a robot (e.g., a robot that is the same as, or similar to, robot 110). In certain examples, at least some aspects of the robotic system 120 can be implemented by a system remote from the robotic system 120.

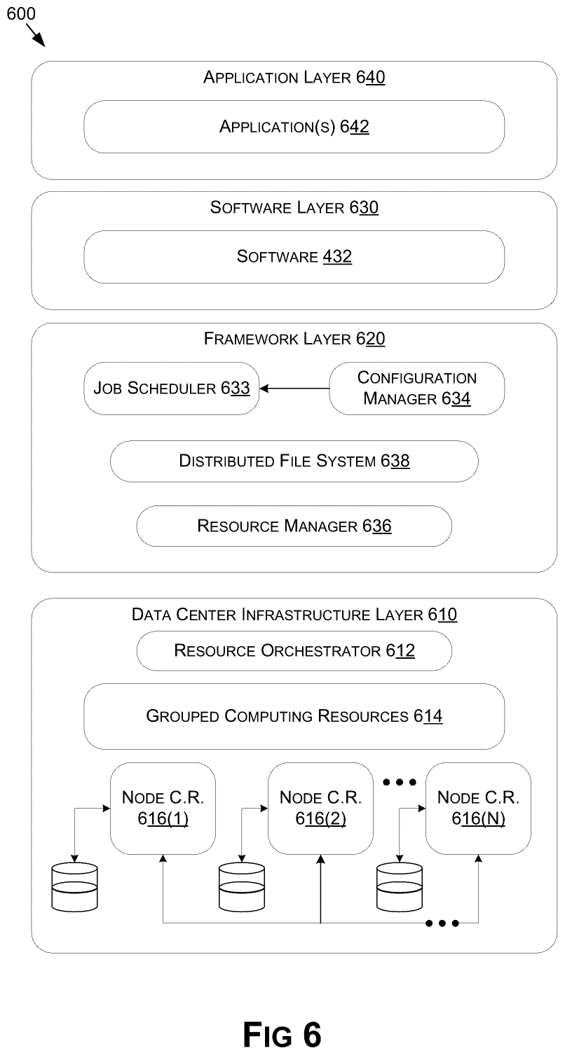

In some embodiments, the systems, methods, and processes described herein may be executed using similar components, features, and/or functionality to those of example autonomous vehicle 400 of FIGS. 4A-4D, example computing device 500 of FIG. 5, and/or example data center 600 of FIG. 6.

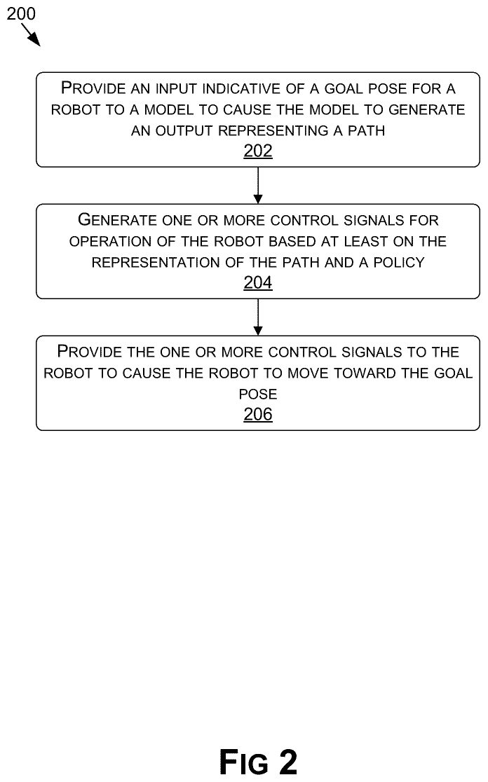

Now referring to FIG. 2, each block of method 200, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 200 is described, by way of example, with respect to a robotic system (e.g., a robotic system that is the same as, or similar to, the robotic system 120 of FIGS. 1A and 1B) when controlling a robot (e.g., a robot that is the same as, or similar to, the robot 110 of FIG. 1A). However, these methods may additionally or alternatively be executed by any one system, or any combination of systems, including, but not limited to, those described herein.

FIG. 2 is a flow diagram showing a method 200 involving the implementation of geometric fabrics for accelerated policy learning and sim-to-real transfer in robotics systems, platforms, and/or applications, in accordance with some embodiments of the present disclosure. The method 200 can be implemented by one or more systems, devices, or components discussed herein.

The method 200, at block 202, includes providing an input indicative of a goal pose for a robot to a model, to cause the model to generate an output representing a path. For example, a robotic system can provide an input indicative of a goal pose for a robot to a model, to cause the model to generate an output representing a path along which the robot can move when advancing toward a goal pose. In some embodiments, the input indicative of the goal pose can be received and/or determined by a planning system (e.g., a planning system that is the same as, or similar to, the planning system 124 of FIG. 1B). For example, the planning system can receive the data associated with the goal pose based at least on input provided by a human operator, a system involved in managing operation of the robot 110 to perform one or more predefined tasks, and/or the like, and the planning system can determine the input to the model based at least on the data associated with the goal pose. In some embodiments, the output represents a plurality of points along the path. The plurality of points can include points to which the robot can move to, each point being associated with a pose of the robot within the environment.

In examples, the robotic system provides an initial pose of the robot relative to an environment (e.g., an environment that is the same as, or similar to, the environment 100 of FIG. 1A), the goal pose for the robot relative to the environment, and a pose of one or more objects relative to the environment. In these examples, the output can be generated based at least on the initial pose of the robot, the goal pose of the robot, and the pose of one or more objects relative to the environment to cause the model to generate the output. In examples, the output is configured to cause the robot to move toward one or more objects in the environment and to cause the robot to engage with one or more of the objects in the environment. In some examples, the output is configured to cause the robot to avoid the one or more objects in the environment.

In some embodiments, the robotic system determines a type of maneuver associated with the input to the model. For example, the robotic system can determine the type of maneuver, where the type of maneuver includes maneuvering toward one or more objects to engage with the one or more objects, maneuvering away from the one or more objects when maneuvering through the environment, and/or the like. In some embodiments, the robotic system determines a model based at least on the type of maneuver associated with the input to the model. For example, where the robotic system is associated with multiple models (e.g., multiple models implemented by a path generator that is the same as, or similar to, the path generator 124c of FIG. 1B), each model can be trained and/or updated to cause the robot to operate in accordance with the type of maneuver. In some embodiments, each model can be trained and/or updated based at least on one or more reinforcement learning-based techniques to perform the maneuver, as described herein. In some embodiments, the robotic system provides the input to the model based at least on the robotic system determining the model from among a plurality of models.

In some embodiments, the robotic system determines (e.g., selects) models described that include reinforcement learning-based models trained and/or updated to generate the outputs described herein based at least on a policy. For example, the models described herein can be trained and/or updated using a simulator that is generating a simulated environment. In this example, the models can be trained and/or updated based at least on operations performed by an agent operating within the simulated environment, the operations corresponding to performance of a maneuver (e.g., moving toward, grasping, and/or the like) involving the robot.

In some embodiments, during training and/or updating, the models can be provided with an initial pose of the robot, a goal pose of the robot, and/or a pose of the one or more objects in the environment, each pose being represented relative to the simulated environment, and the model can generate an output. The output can represent a plurality of points along a path and/or a set of control signals along which the robot can move. During simulation, robotic system can cause the path generator to provide the output to a policy fabric (e.g., a policy fabric that is the same as, or similar to, the policy fabric 124e of FIG. 1B) implementing a geometric fabric as described herein. The policy fabric can then generate and provide a set of control signals based at least on the output of the model to the simulator to cause the agent in the simulated environment to move from an initial pose to one or more intermediate poses while attempting to reach a goal pose.

During operation of the robot in the simulated environment, a reward can be assigned for successful movement of the robot toward the goal pose, and a penalty can be assigned for unsuccessful movement of the robot. In some embodiments, the model can be trained and/or updated based at least on the rewards and the penalties assigned to the movements of the robot within the simulated environment. Training and/or updating of the model can continue until a number of rewards are obtained and a number of penalties are minimized (e.g., until the model converges).

The method 200, at block 204, includes generating one or more control signals for operation of the robot based at least on the representation of the path and a policy. In some embodiments, the robotic system can cause the model to generate the one or more control signals based at least on the robotic system providing the input to the model. In embodiments, the robotic system can cause the policy fabric to generate the one or more control signals based at least on the robotic system providing the output of the model as an input to the policy fabric. In these examples, the policy fabric can generate control signals based at least on a policy corresponding to one or more criteria for the operation of the robot. For example, the policy fabric can implement a policy, where the policy represents one or more criteria for operation of the robot (e.g., one or more thresholds relating to parameters for operation of one or more actuators or motors of the robot, such as relating to speed and/or torque thresholds) that are based at least on second-order differential equations as described herein. In some embodiments, where the policy fabric receives control signals that are output by the mode, the policy fabric can generate updated control signals that are complaint with the policy implemented by the policy fabric. In this way, in the examples described herein, the policy fabric can generate control signals that are compliant with a geometric fabric as described herein.

The method 200, at block 206, includes providing the one or more control signals to the robot to cause the robot to move toward the goal pose. For example, the robotic system can provide the one or more control signals to the robot based at least on the robotic system causing the policy fabric to generate the one or more control signals. In some embodiments, the robotic system can provide a set of control signals to the robot. For example, the robotic system can provide a set of control signals to the robot to cause the robot to operate in accordance with the control signals. In some embodiments, each control signal of the set of control signals is configured to cause at least one actuator associated with a corresponding joint of the robot to move. For example, each control signal can be configured to cause the at least one actuator to move at least a portion of the robot from the first pose to a second pose of the at least one intermediate pose, and so on, until the robot reaches a goal pose.

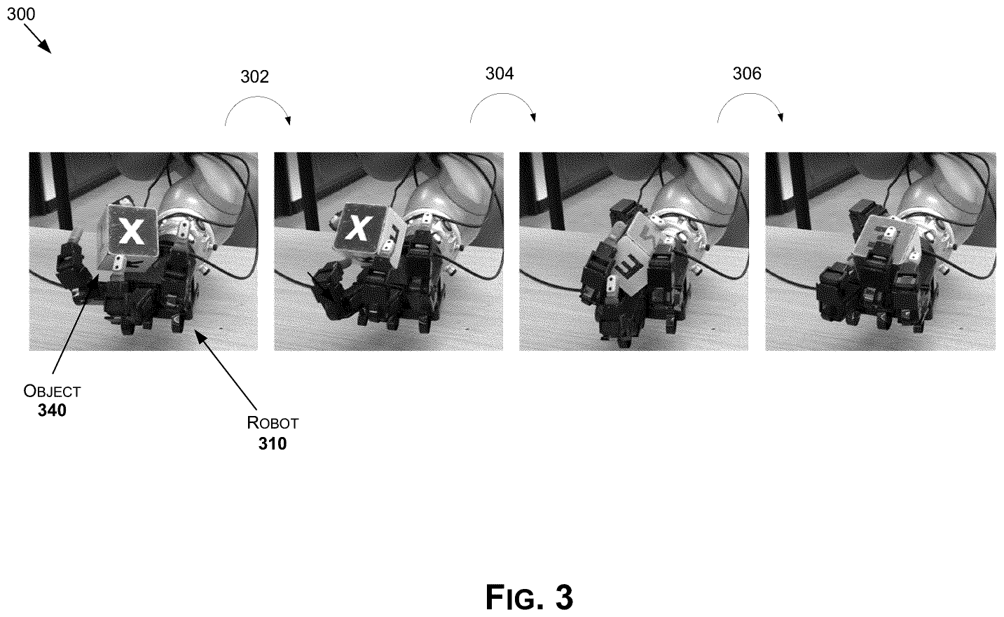

Now referring to FIG. 3, depicted is an example set of motions performed by a robotic system, in accordance with some embodiments of the present disclosure. FIG. 3 includes a robot 310 and an object 340. The robot 310 can be a robot that is the same as, or similar to, the robot 110 of FIG. 1A. The object 340 can be an object that is the same as, or similar to, object 140 of FIG. 1A.

As depicted by FIG. 3, the robot 110 operates such that the object 340 is rotated based at least on one or more maneuvers performed by the robot 310. More specifically, the object 340 is associated with an initial pose where a face of the object 340 (the face with the letter “X” displayed thereon) is pointing upward relative to other faces of the object 340. As referenced by reference number 302, as the robot 310 performs a first maneuver, the robot 310 engages the object 340 by actuating a plurality of actuators associated with the robot 110 that apply forces to the object 340 when rotating the object. In this way, the object 340 is rotated clockwise relative to the robot 310 from the initial pose to an intermediate pose (referred to as a first intermediate pose).

As referenced by reference number 304, as the robot 310 performs a second maneuver, the robot 310 engages the object 340 by actuating the plurality of actuators associated with the robot 110 that apply forces to the object 340 when rotating the object. In this way, the object 340 is further rotated clockwise relative to the robot 310 from the first intermediate pose to a second intermediate pose. In this example, the second maneuver may be the same as, or similar to, the first maneuver.

As referenced by reference number 306, as the robot 310 performs a third maneuver, the robot 310 engages the object 340 by actuating the plurality of actuators associated with the robot 110 that apply forces to the object 340 when rotating the object. In this way, the object 340 is flipped relative to the robot 310 from the second intermediate pose to a goal pose. In this example, the third maneuver is different from the first maneuver and/or the second maneuver.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LiDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the High Definition (“HD”) map 422 of FIG. 4C), location data (e.g., the vehicle's 400 location, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424 which may use one or more wireless antenna(s) 426 and/or modem(s) to communicate over one or more networks. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may be any number (including zero) of wide-view cameras 470 on the vehicle 400. In addition, any number of long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

Any number of stereo cameras 468 may also be included in a front-facing configuration. In at least one embodiment, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360 degree camera(s), and/or the like. Four example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C are illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400, and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LiDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 412 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high-dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LiDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based at least on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surroundings at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 460 m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LiDAR sensor(s) 464. The LiDAR sensor(s) 464 may be used for object and pedestrian detection, emergency braking, collision avoidance, and/or other functions. The LiDAR sensor(s) 464 may be functional safety level ASIL B. In some examples, the vehicle 400 may include multiple LiDAR sensors 464 (e.g., two, four, six, etc.) that may use Ethernet (e.g., to provide data to a Gigabit Ethernet switch).

In some examples, the LiDAR sensor(s) 464 may be capable of providing a list of objects and their distances for a 360-degree field of view. Commercially available LiDAR sensor(s) 464 may have an advertised range of approximately 400 m, with an accuracy of 2 cm-3 cm, and with support for a 400 Mbps Ethernet connection, for example. In some examples, one or more non-protruding LiDAR sensors 464 may be used. In such examples, the LiDAR sensor(s) 464 may be implemented as a small device that may be embedded into the front, rear, sides, and/or corners of the vehicle 400. The LiDAR sensor(s) 464, in such examples, may provide up to a 120-degree horizontal and 35-degree vertical field-of-view, with a 200 m range even for low-reflectivity objects. Front-mounted LiDAR sensor(s) 464 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 400. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality. In some embodiments, some or all of the functions performed by the ADAS system 438 can implement one or more of the techniques described herein such as, for example, the generation of control signals using one or more models and a policy fabric to control operation (e.g., steering, acceleration, braking, and/or the like) of the vehicle 400.

The ACC systems may use RADAR sensor(s) 460, LiDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 400), while the 12V communication concept provides information about traffic further ahead. CACC systems may include either or both I2V and V2V information sources. Given the information of the vehicles ahead of the vehicle 400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based at least on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network which is trained and thus reduces the risk of false positives, as described herein.

The vehicle 400 may further include the infotainment SoC 430 (e.g., an in-vehicle infotainment system (IVI)). Although illustrated and described as a SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 400. For example, the infotainment SoC 430 may radios, disk players, navigation systems, video players, USB and Bluetooth connectivity, carputers, in-car entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road-work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based at least on training performed at a datacenter (e.g., using the server(s) 478 and/or other servers).

The server(s) 478 may be used to train machine learning models (e.g., neural networks) based at least on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof. In some embodiments, the computing device 500 can be configured to implement one or more of the functions described herein. For example, the computing device 500 can be configured to implement one or more of the functions of the sensors 102, the robot 110, and/or the robotic system 120 of FIG. 1A when generating control signals to operate the robot 110.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 633, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 633 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 633. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based at least on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train and/or update one or more machine learning models or predict or infer information using one or more machine learning models according to one or more embodiments described herein. For example, a machine learning model(s) may be trained and/or updated by calculating weight parameters according to a neural network architecture using software and/or computing resources described above with respect to the data center 600. In at least one embodiment, trained, updated, or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

In some embodiments, the data center 600 can be used when training and/or updating one or more of the models described herein. For example, the data center 600 can train and/or update one or more of the reinforcement learning-based models described with respect to FIGS. 1A and 1B, and FIG. 2, in cooperation with one or more computing devices that are the same as, or similar to, the computing device 500 of FIG. 5.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
provide an input indicative of a goal pose for a robot to a model to cause the model to generate an output, the output representing a plurality of points along a path for movement of the robot to the goal pose;
generate one or more control signals for operation of the robot based at least on the plurality of points along the path and a policy corresponding to one or more criteria for the operation of the robot; and
provide the one or more control signals to the robot to cause the robot to move toward the goal pose.

2. The one or more processors of claim 1, wherein the model is a reinforcement learning-based model, and
wherein the reinforcement learning-based model is updated to generate the output based at least on the policy.

3. The one or more processors of claim 1, wherein, when providing the input indicative of the goal pose for the robot to the model, the one or more circuits are to:
provide an initial pose of the robot relative to an environment, the goal pose for the robot relative to the environment, and a pose of one or more objects relative to the environment in which the robot is operating to the model to cause the model to generate the output.

4. The one or more processors of claim 3, wherein, when generating the one or more control signals for operation of the robot, the one or more circuits are to:
determine a set of control signals to move the robot between a first pose and at least one intermediate pose along the path based at least on the output of the model, and
provide the set of control signals to cause a second output to be generated based at least on the policy, the second output comprising an updated set of control signals representing an updated path that is compliant with a geometric fabric.

5. The one or more processors of claim 4, wherein each control signal of the set of control signals is configured to cause at least one actuator associated with a corresponding joint of the robot to move at least a portion of the robot from the first pose to a second pose of the at least one intermediate pose.

6. The one or more processors of claim 1, wherein the one or more circuits are to:
determine a type of maneuver associated with the input to the model,
wherein, when providing the input to the model, the one or more circuits are to:
provide the input to the model based at least on the type of maneuver associated with the path.

7. The one or more processors of claim 1, wherein, when providing the input to the model, the one or more circuits are to:
determine the model from among a plurality of models, the model associated with the robot; and
provide the input to the model based at least on determining the model.

8. The one or more processors of claim 1, wherein the one or more criteria represented by the policy comprises at least one criteria based at least on a second-order differential equation.

9. The one or more processors of claim 1, wherein the one or more circuits are to:
simulate operation of the robot in a simulated environment, and
wherein the one or more circuits that provide the one or more control signals to the robot to cause the robot to move toward the goal pose are to:
provide the one or more control signals to the robot while operating in the simulated environment to cause the robot to move in the simulated environment.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for generating or presenting at least one of augmented reality content, virtual reality content, or mixed reality content;
a system for hosting one or more real-time streaming applications;
a system for implementing large language models (LLMs);
a system for implementing vision language models (VLMs);
a system implemented using an edge device;
a system implemented using a robot;
a system for performing conversational AI operations;
a system for performing generative AI operations;
a system for generating synthetic data;
a system incorporating one or more virtual machines (VMs);
a system implemented at least partially in a data center; or
a system implemented at least partially using cloud computing resources.

11. A system comprising:
one or more processors to perform operations comprising:
providing an input indicative of a goal pose for a robot to a model;
generating an output using the model, the output representing a plurality of points along a path for movement of the robot to the goal pose;
generating one or more control signals for operation of the robot based at least on the plurality of points along the path and a policy corresponding to one or more criteria for the operation of the robot; and
providing the one or more control signals to the robot to cause the robot to move toward the goal pose.

12. The system of claim 11, wherein the model is a reinforcement learning-based model, and
wherein the reinforcement learning-based model is updated to generate the output based at least on the policy.

13. The system of claim 11, wherein, when providing the input indicative of the goal pose for the robot to the model, the one or more processors perform the operations of:
providing an initial pose of the robot relative to an environment, the goal pose for the robot relative to the environment, and a pose of one or more objects relative to the environment in which the robot is operating to the model to cause the model to generate the output.

14. The system of claim 13, wherein, when generating the one or more control signals for operation of the robot, the one or more processors perform the operations of:
determining a set of control signals to move the robot between a first pose and at least one intermediate pose along the path based at least on the output of the model, and
providing the set of control signals to cause a second output to be generated based at least on the policy, the second output comprising an updated set of control signals representing an updated path that is compliant with a geometric fabric.

15. The system of claim 14, wherein each control signal of the set of control signals is configured to cause at least one actuator associated with a corresponding joint of the robot to move at least a portion of the robot from the first pose to a second pose of the at least one intermediate pose.

16. The system of claim 11, wherein the one or more processors perform the operations of:
determining a type of maneuver associated with the input to the model,
wherein, when providing the input to the model, the one or more processors perform the operations of:
providing the input to the model based at least on the type of maneuver associated with the path.

17. The system of claim 11, wherein, when providing the input to the model, the one or more processors perform the operations of:
determining the model from among a plurality of models, the model associated with the robot; and
providing the input to the model based at least on determining the model.

18. The system of claim 11, wherein the one or more criteria represented by the policy comprises at least one criteria based at least on a second-order differential equation.

19. The system of claim 11, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for generating or presenting at least one of augmented reality content, virtual reality content, or mixed reality content;
a system for hosting one or more real-time streaming applications;
a system for performing generative AI operations;
a system for implementing large language models (LLMs);
a system for implementing vision language models (VLMs);
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

20. A method comprising:
providing an input indicative of a goal pose for a robot to a model to cause the model to generate an output representing a plurality of points along a path for movement of the robot to the goal pose;
generating one or more control signals for operation of the robot using the plurality of points along the path and based at least on a policy corresponding to one or more criteria for the operation of the robot; and
providing the one or more control signals to the robot to cause the robot to move toward the goal pose.
